(19) United States
(12) Patent Application Publication
(10) Pub. No.: US 2014/0331542 A1
(43) Pub. Date: Nov. 13, 2014

(54) Materials and Method for Waterfowl Decoy Rigging Systems

(71) Applicant: Peter Andrews, Houston, TX (US)

(72) Inventor: Peter Andrews, Houston, TX (US)

(21) Appl. No.: 13/892,153

(22) Filed: May 10, 2013

(51) Int. Cl. A01M 31/06

(52) U.S. Cl. CPC A01M 31/06
USPC 43/3

(57) ABSTRACT

A waterfowl decoy rigging system comprising a polyvinyl chloride-coated, galvanized steel line material, a waterfowl decoy attached to the line material, and a weighted anchor attached to the line material, and a method of using said waterfowl decoy rigging system.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention.

The present disclosure generally relates to material and related methods involving waterfowl decoy rigging systems employed for waterfowl hunting.

2. Background.

The background information discussed below is presented to illustrate the novelty and utility of the Applicant's invention. This background information is not admitted prior art.

Hunting for food has been a necessary activity for human survival dating back to the earliest civilizations known to man. That is to say, the human race has survived by developing the skills of hunting and gathering. More specific to this application, wild waterfowl have been hunted for food and feathers since prehistoric times. Ancient Peruvian art dated 200 B.C., ancient Egyptian paintings dated 1900 B.C., and Ice Age European cave paintings have been found depicting men hunting and trapping ducks, geese, and swans.

Today, waterfowl hunting is an outdoor sporting activity which involves the practice of stalking and killing ducks, geese, and other waterfowl for food or enjoyment. Other types of waterfowl that might be hunted include mallards, Canadian geese, show geese, pintail, gadwall, harlequin, wood duck, oldsquaw, and scoter. Swans are also hunted in many countries, particularly in the Arctic region, but they are generally protected in the United States and the United Kingdom because they are historically considered a royal prerogative. Most waterfowl share a common habitat (e.g., bodies of water such as rivers, lakes, swamps, and oceans, and the land surrounding them) and are hunted using the same or similar methods.

Primitive devices such as hunting blinds, water traps, and arrows have since given way to modern hunting techniques that often employ a variety of devices including calls, blinds, and decoys, as well as hunting dogs, camouflage clothing, shotguns and boats. Hunters typically use camouflage and blinds to conceal themselves from the waterfowl. Shotguns are typically the weapon of choice, and hunting dogs (typically Labrador Retrievers, Golden Retrievers, or Chesapeake Bay Retrievers) and boats are used to retrieve the fallen waterfowl.

Frequently, waterfowl calls are used in conjunction with decoys in order to lure potential waterfowl prey flying overhead to a particular location. Often, the effective use of decoys is imperative to a successful hunt. In operation, decoys often simulate the look, and sometimes the movement, of waterfowl to attractive waterfowl by the false appearance of safety in the area. Sometimes, floating decoys are deployed on a body of water and typically one end of a cord or line is attached to a keel on the underside of the decoy while the other end of the cord or line is attached to an anchor. The anchor sinks to the bottom of the body of water and holds the floating decoy in place on the water's surface despite changing tide levels, wind gusts, or water currents. This line and anchor system is sometimes referred to as a “rigging system.”

Usually, hunters employ multiple, even dozens, of decoys at one tide. However, this practice can have unsatisfactory results because the adjacent rigging systems can also become entangled with each other or water plants. For example, two or more decoys are often placed within dose proximity of each other in the body of water. Currents in the water may displace the anchors and the rigging system cords between adjacent decoy units can easily become entangled creating a time-exhausting task for the waterfowl hunter. Moreover, multiple, even dozens, of decoys are often carried together to the desired location prior to deployment. For effective deployment, each individual decoy must be able to be easily separated from the other decoys without its rigging system becoming entangled with other adjacent decoys and decoy rigging systems. Current technologies that utilize monofilament or other types of memory-retaining lines easily become entangled and crimped during this process, making removal of individual decoys for deployment a time-exhausting task.

Unsatisfactory results of current rigging systems can manifest in decoy use or storage. Unfortunately, current technologies often utilize monofilament or other types of memory-retaining lines for use in their rigging systems. These memory-retaining lines lead to crimped; knotted; and tangled lines; which can occur both at the hunting site and during storage of multiple decoy rigging system units. This can become a time-consuming and frustrating problem for waterfowl hunters. Additionally, the materials used for lines of rigging systems are susceptible to durability issues which can lead to cracking and breaking, especially when used in cold weather. In other words, current materials force waterfowl hunters to replace expensive decoy rigging systems at undesirable frequencies.

There have been some notable attempts to address the problem of preventing tangled, crimped, and/or knotted waterfowl decoy rigging system lines, as well as the durability issues associated with such lines. However, they have not taken the approach of the embodiments of the present application or are inadequate for a variety of reasons. For example, U.S. Pat. No. 8,028,462 to Sieman teaches a rigid, rod based rigging system, but this type of system is cumbersome and takes up too much space since the rigid rod system prevents the user from being able to roll or spool the line into a condensed, compact unit. U.S. Pat. No. 6,857,216 to Merin teaches a rigging system wherein the anchor is coated in a protective rubber material, but neither contemplates adding durability protection to the line itself, nor does its design prevent tangling. U.S. Pat, No 2,616,200 to Milam teaches a rigging system featuring a rigid “spreader.” This previous technology keeps a limited number of decoys a certain distance away from one another, but does not adequately prevent tangling of the lines. Moreover, the technology is awkward to assemble, cumbersome to carry, and can become increasingly complicated with the introduction of additional decoys.

While each of these attempts is noteworthy, current technologies fail to adequately address the common frustrating problem of tangled, crimped, and/or knotted lines used in conjunction with decoy rigging systems employed during waterfowl hunting, Furthermore, the previous technologies suffer from durability issues that lead to cracking and breaking, and eventually waterfowl hunters must replace expensive decoy rigging systems at an undesirable frequency. Many of the previous technologies are unlikely to be embraced by users by reason of awkwardness of use, cumbersome design, overly complicated mechanisms, or expensive retail prices as a result of the overly complicated mechanisms.

### SUMMARY OF THE INVENTION

In view of the foregoing, it is an object of the present application to provide a waterfowl decoy rigging system employed during waterfowl hunting.

It is another objective of the present application to provide a line material for waterfowl decoy rigging systems employed during waterfowl hunting that resists crimping, tangling, and knotting.

It is another objective of the present application to provide a line material for waterfowl decoy rigging systems employed during waterfowl hunting that exhibits superior durability and resists cracking and breaking.

It is another objective of the present application to provide a clip utilized in waterfowl decoy rigging systems employed during waterfowl hunting that attaches to the waterfowl decoy keel and allows the line material to move freely through the eye of the clip, enabling the waterfowl decoy to slide up and down the line material. Additionally, the clip can slide freely up and down the line, but cannot be removed from the line because the diameter of the eye of the clip is smaller than the diameter of the double barreled crimps on each end of the line.

It is another objective of the present application to provide an anchor for waterfowl decoy rigging systems employed during waterfowl hunting. The anchor has an attachment hole that is used to secure it in place so it cannot be removed. The anchor is secured in place by feeding the line through one barrel of a double barreled crimp, feeding the line through the attachment hole in the anchor, bending the line, feeding the end through the second barrel of the double barreled crimp, and tightening the second double barrel crimp to lock the anchor in place.

It is yet another objective of the present application to provide a method of using the said waterfowl decoy rigging system, In a preferable embodiment, the method comprises the steps of: obtaining a piece of polyvinyl chloride-coated line material; cutting the piece of polyvinyl chloride-coated line material to a desired length; feeding the polyvinyl chloride-coated line through one barrel of a double barrel crimp; bending the polyvinyl chloride-coated line to form a loop; feeding the polyvinyl chloride-coated line through a second barrel of the double barrel crimp; tightening the double barrel crimp to form a locked-in loop; feeding the second end of the polyvinyl chloride-coated line material through a hole on a clip; attaching the clip to a waterfowl decoy; feeding the second end of the polyvinyl chloride-coated line through one barrel of a second double barrel crimp; feeding the second end of the polyvinyl chloride-coated line through an attachment hole on a weighted anchor; bending the second end of the polyvinyl chloride-coated line to form a second loop; feeding the second end of the polyvinyl chloride-coated line through a second barrel of the second double barrel crimp; and, tightening the second double barrel crimp to form a second locked-in loop.

Other objectives of the invention will become apparent to those skilled in the art once the invention has been shown and described. These objectives are not to be construed as limitations of applicant's invention, but are merely aimed to suggest some of the many benefits that may be realized by the apparatus and methods of the present application and with its many embodiments.

### BRIEF DESCRIPTION OF THE FIGURES

The manner in which these objectives and other desirable characteristics can be obtained is better explained in the following description and attached figures in which:

FIG. 1 is a perspective view of an embodiment of a decoy rigging system attached to a waterfowl decoy.

FIG. 2 is a close, perspective view of a preferable embodiment of a clip of said decoy rigging system.

FIG. 3 is a cutaway perspective view of a preferable embodiment of a polyvinyl chloride-coated line material.

FIG. 4 is a cross section view of a preferable embodiment of the polyvinyl chloride-coated line material.

FIG. 5 is a flow chart of a method for using the decoy rigging system implementing the polyvinyl chloride-coated line material.

It is to be noted, however, that the appended figures illustrate only typical embodiments disclosed in this application, and therefore, are not to be considered limiting of its scope, for the invention may admit to other equally effective embodiments that will be appreciated by those reasonably skilled in the relevant arts, Also, figures are not necessarily made to scale.

### DETAILED DESCRIPTION OF PREFFERED EMBODIMENTS

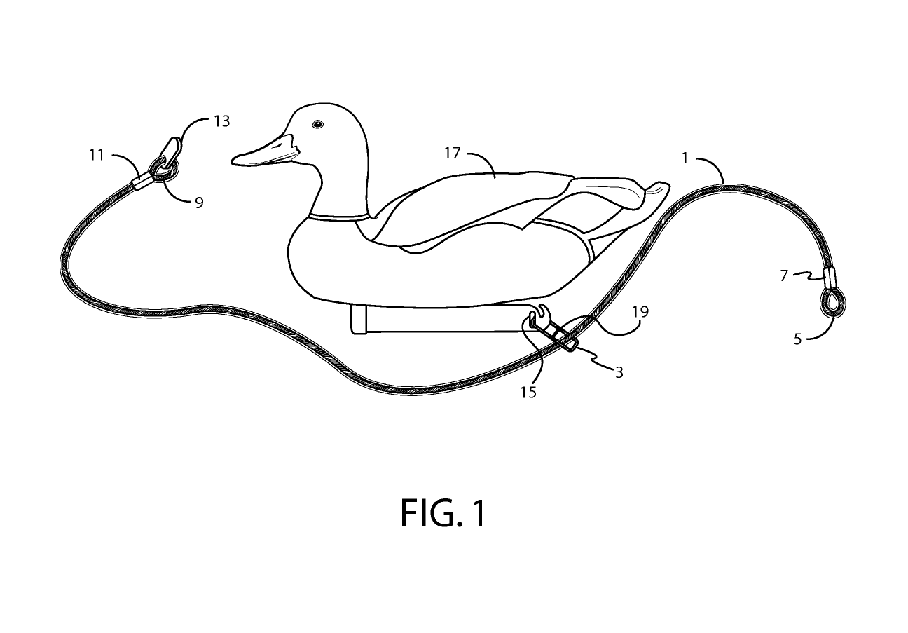

FIG. 1 is a perspective view of a preferable embodiment of this application where a typical waterfowl decoy rigging system has been improved through the implementation of a polyvinyl chloride-coated line material that prevents tangling, crimping, and knotting while additionally providing increased durability. The system includes a polyvinyl chloride-coated line 1 that is strung through a waterfowl attachment clip 3, allowing the polyvinyl chloride-coated line 1 to slide freely through the waterfowl attachment dip 3. The polyvinyl chloride-coated line 1 has a loop 5 locked-in place by a double barrel crimp 7 at one end. On the opposite end of the polyvinyl chloride-coated line 1, a weighted anchor 13 is locked into an anchor loop 9 by an anchor loop double barrel crimp 11. The weighted anchor 13 is locked into the anchor bop 9 by feeding one end of the polyvinyl chloride-coated line 1 through one barrel of the anchor loop double barrel crimp 11, bending the polyvinyl chloride-coated line 1 to form the anchor loop 9, feeding the polyvinyl chloride-coated line 1 through a second barrel of the anchor loop double barrel crimp 11, and tightening the anchor bop double barrel crimp to form the locked-in anchor loop 9. A weighted anchor 13 is attached to the anchor loop 9. The waterfowl attachment clip 3 is attached to an attachment hole 15 on a waterfowl decoy 17 by a dip locking mechanism 19.

The polyvinyl chloride-coated line 1 improves upon an ordinary monofilament line by preventing tangling, crimping, and knotting. Normal use during waterfowl hunting using monofilament lines often results in tangling, crimping, and knotting because monofilament lines are memory retaining. Conversely, the polyvinyl chloride-coated line 1 is not memory retaining in that its properties inherently compel the line to stay straight, while still retaining flexibility. For example, when retrieving a waterfowl decoy attached to a rigging system, the decoy may get caught on a plant or rock. Upon further pulling of a monofilament line, the line could become crimped. Furthermore, the line could become tangled or knotted with itself, or with other monofilament lines if multiple. waterfowl decoys are used. Conversely, a polyvinyl chloride-coated line 1 used in the same context as the aforementioned example would not crimp. Pulling the polyvinyl chloride-coated line 1 would only temporarily crease the polyvinyl chloride-coated line 1, and it would immediately return to its uncrimped or uncreased state upon release of tension from the line. Moreover, the polyvinyl chloride-coated line's 1 properties resist tangling and knotting with itself and other lines while also preventing any tight knot formation.

Additionally, the polyvinyl chloride-coated line 1 improves upon an ordinary monofilament line by providing additional durability to resist cracking and breaking of the line. This is accomplished through both the superior durability properties of the polyvinyl chloride-coated lines 1 over typical monofilament lines and also the prevention of repeated crimping which can lead to premature damage, cracking, and breaking of the lines.

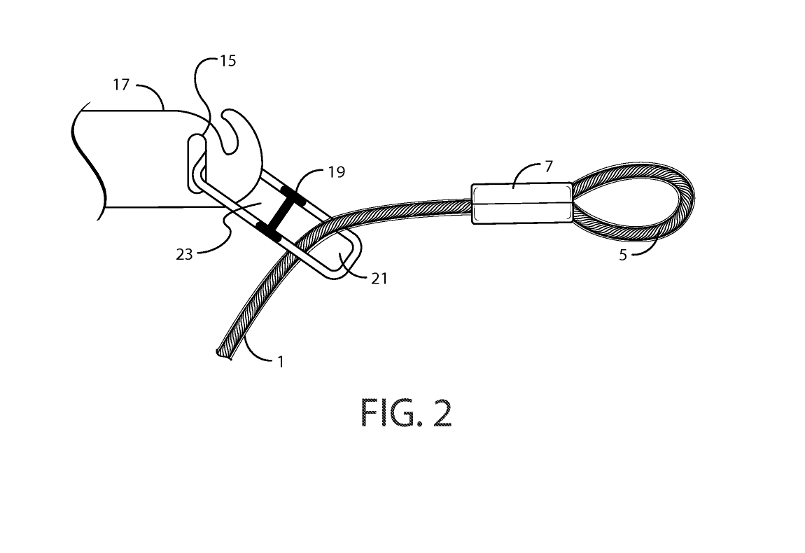

FIG. 2 is a perspective view of a preferable embodiment of waterfowl attachment clip 3. The polyvinyl chloride-coated line 1 is strung through a first loop 21 of the waterfowl attachment clip 3, allowing the polyvinyl chloride-coated line 1 to slide freely through the waterfowl attachment clip 3. The free movement of the polyvinyl chloride-coated line 1 through the waterfowl attachment clip 3 encourages lifelike movement of the waterfowl decoy 17 on top of a body of water and also provides slack to prevent tangling and knotting. Moreover, the waterfowl attachment clip 3 allows the polyvinyl chloride-coated line 1 and weighted anchor 13 to slide freely to the bottom of the body of water where the waterfowl decoy 17 is deployed. This causes the loop 5 to rest near the attachment hole 15 of the waterfowl decoy 17, allowing for greatly improved retrieval time. The loop 5 is locked-in by the double barrel crimp 7 that prevents the polyvinyl chloride-coated line 1 from sliding out of the waterfowl attachment clip 3 because the diameter of the double barrel crimp 7 is larger in size than the diameter of the first loop 21 of the waterfowl attachment clip 3 (the loop of the clip through which the polyvinyl chloride-coated line slides). On the other end of the polyvinyl chloride-coated line 1, the weighted anchor 13 (see FIG. 1) and anchor loop 9 (see FIG. 1) are locked-in by the anchor loop double barrel crimp 11 (see FIG. 1) that prevents the polyvinyl chloride-coated line 1 from sliding out of the waterfowl attachment clip 3 because the diameter of the double barrel crimp 7 is larger n size than the diameter of the first loop 21 of the waterfowl attachment clip 3 (the loop of the clip through which the polyvinyl chloride-coated line slides) A second loop 23 of the waterfowl attachment clip 3 is utilized to attach to the attachment hole 15 of the waterfowl decoy 17 using a clip locking mechanism 19 that can be opened, closed, and locked.

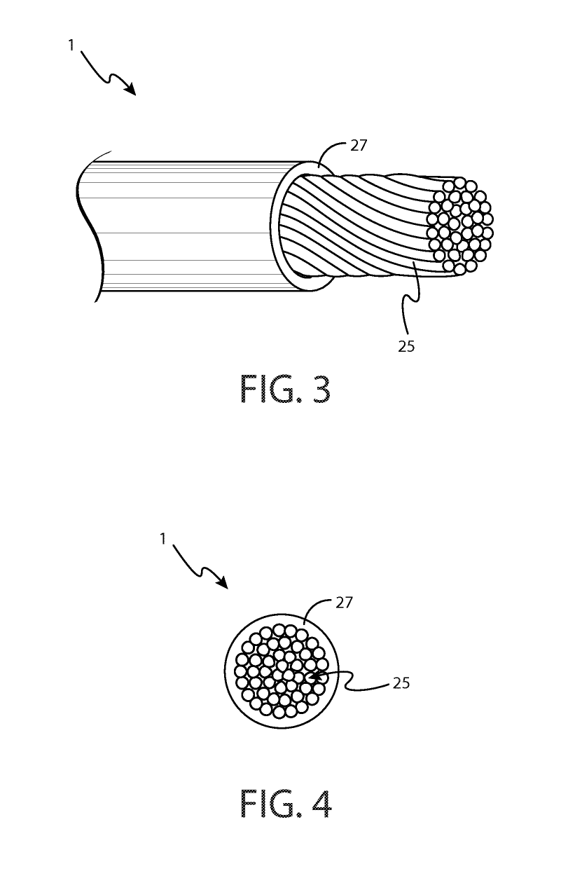

FIG. 3 is a cutaway perspective view of a preferable embodiment of the polyvinyl chloride-coated line 1. A galvanized steel wire cable 25 with a 7×7 strand core construction and a diameter of 1.59 mm is enveloped by a polyvinyl chloride material 27 with a thickness of 0.79 mm. The resulting polyvinyl chloride-coated line 1 has an outside diameter of 2.38 mm and possesses a minimum breaking load of 218 kg. While these parameters describe one preferable embodiment of the polyvinyl chloride-coated line 1, other galvanized steel wire cable 25 diameters, polyvinyl chloride material 27 thicknesses, and polyvinyl chloride-coated line 1 minimum breaking loads can be used in different embodiments of the present invention while still maintaining the benefits of the present invention.

FIG. 4 is a cross section view of a preferable embodiment of the polyvinyl chloride-coated line 1. A galvanized steel wire cable 25 with a 7×7 strand core construction and a diameter of 1.59 mm is enveloped by a polyvinyl chloride material 27 with a thickness of 0.79 mm. The resulting polyvinyl chloride-coated line 1 has an outside diameter of 2.38 mm and possesses a minimum breaking load of 218 kg. While these parameters describe one preferable embodiment of the polyvinyl chloride-coated line 1, other galvanized steel wire cable 25 diameters, polyvinyl chloride material 27 thicknesses, and polyvinyl chloride-coated line 1 minimum breaking loads can be used in different embodiments of the present invention while still maintaining the benefits of the present invention,

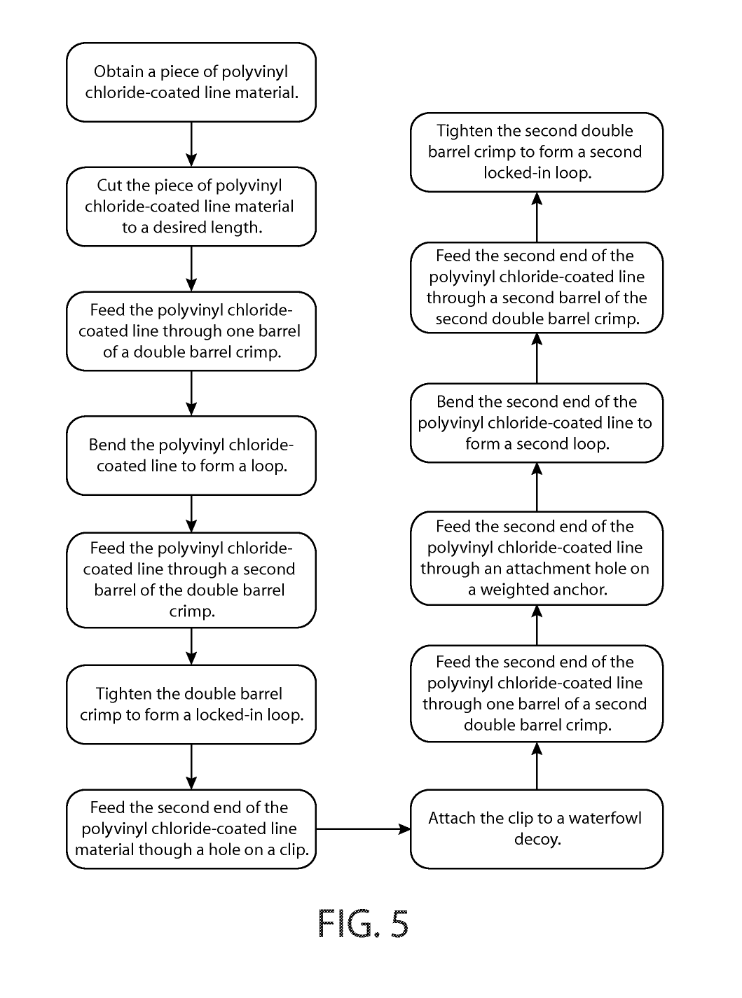

FIG. 5 is a flowchart of a method using a preferable embodiment of the waterfowl rigging system described in the present application. The method comprises the steps of: obtaining a piece of polyvinyl chloride-coated line material; cutting the piece of polyvinyl chloride-coated line material to a desired length; feeding the polyvinyl chloride-coated line through one barrel of a double barrel crimp; bending the polyvinyl chloride-coated line to form a loop; feeding the polyvinyl chloride-coated line through a second barrel of the double barrel crimp; tightening the double barrel crimp to form a locked-in loop; feeding the second end of the polyvinyl chloride-coated line material through a hole on a clip; attaching the clip to a waterfowl decoy; feeding the second end of the polyvinyl chloride-coated line through one barrel of a second double barrel crimp; feeding the second end of the polyvinyl chloride-coated line through an attachment hole on a weighted anchor; bending the second end of the polyvinyl chloride-coated line to form a second loop; feeding the second end of the polyvinyl chloride-coated line through a second barrel of the second double barrel crimp; and, tightening the second double barrel crimp to form a second locked-in loop.

The invention claimed is:

1. A waterfowl decoy rigging system comprising:
a line material;
a waterfowl decoy attached to the line material; and,
a weighted anchor attached to the line material.

2. The system of claim 1 wherein the line material is comprised of a central galvanized steel core.

3. The system of claim 2 wherein the line material is further comprised of a polyvinyl chloride-coating that surrounds the central galvanized steel core around its diameter.

4. The system of claim 3 further comprising a clip that removably attaches the line material to the waterfowl decoy.

5. The system of claim 4 wherein the line material passes through a hole in the clip allowing the line material to freely move through the hole, enabling the attached waterfowl decoy to slide up and down the line material.

6. The system of claim 5 wherein the clip implements a locking mechanism that removably attaches to the waterfowl decoy.

7. A method of using a waterfowl decoy rigging system comprising the steps of:
obtaining a piece of line material;
cutting the line material to a desired length;
feeding one end of the line material through one barrel of a crimp;
bending the line material to form a loop;
feeding the line material through a second barrel of the crimp;
tightening the crimp to form a locked-in loop;
feeding the second end of the line material through a hole on a clip;
attaching the clip to a waterfowl decoy;
feeding the second end of the line material through one barrel of a second crimp;
feeding the second end of the line material through a hole on a weighted anchor;
bending the second end of the line material to form a second loop; and,
feeding the second end of the line material through a second barrel of the second crimp.

8. The method of claim 7 wherein the line material is comprised of a central galvanized steel core.

9. The method of claim 8 wherein the line material is further comprised of a polyvinyl chloride-coating that surrounds the central galvanized steel core around its diameter.

10. The method of claim 9 wherein the line material passes through a hole in the clip allowing the line material to freely move through the hole, enabling the attached waterfowl decoy to slide up and down the line material.

11. The method of claim 10 wherein the clip implements a locking mechanism that removably attaches to the waterfowl decoy.

12. A method of using a waterfowl decoy rigging system comprising the steps of:
attaching a waterfowl decoy to a line material;
attaching a weighted anchor to the line material; and
deploying waterfowl decoy into a body of water,
whereby the line material resists knotting, tangling, and crimping.

13. The method of claim 12 wherein the line material is comprised of a central galvanized steel core.

14. The method of claim 13 wherein the line material is further comprised of a polyvinyl chloride-coating that surrounds the central galvanized steel core around its diameter.

15. The method of claim 14 wherein the waterfowl decoy is attached to the line material with a clip

16. The method of claim 15 wherein the line material passes through a hole in the clip allowing the line material to freely move through the hole, enabling the attached waterfowl decoy to slide up and down the line material.

17. The method of claim 16 wherein the clip implements a locking mechanism that removably attaches to the waterfowl decoy.
